(19) United States
(12) Patent Application Publication
(10) Pub. No.: US 2012/0285289 A1
(43) Pub. Date: Nov. 15, 2012

(54) Magnetic steering device for physically handicapped persons

(75) Inventors: Jeff Walker, Centreville, MD (US); Zane Walker, Centreville, MD (US)

(73) Assignee: Innovative Mobility Solutions, LLC, Centreville, MD (US)

(21) Appl. No.: 13/068,363

(22) Filed: May 10, 2011

(51) Int. Cl. B62D 1/06

(52) U.S. Cl. 74/558

(57) ABSTRACT

The present invention relates to an improved steering wheel rotating apparatus that utilizes magnetic forces to permit an individual with reduced strength and/or functioning of his/her arms to more easily control the steering of an automobile.

### CROSS-REFERENCE TO RELATED APPLICATIONS

The present application does not derive priority from any prior applications.

### BACKGROUND OF THE INVENTION

1. Field of the Invention

The present invention relates generally to mechanisms for improving the ability for handicapped individuals to control the steering of a motorized vehicle. More particularly, this invention relates to an improved steering wheel rotating apparatus that utilizes magnetic forces to permit an individual with reduced strength and/or functioning of his/her arms to more easily control the steering of an automobile.

2. Description of the Background

The use of devices to aid in the steering of a vehicle is known in the prior art. Numerous prior devices including spinner knobs, palm grips and tri-pins have been proposed and used for adapting steering controls for use by physically challenged individuals.

Spinner knobs are steering wheel accessories that are small knobs that attach to a vehicle steering wheel and fit into the palm of a person's hand. The idea behind these knobs is that the operator of the vehicle can grab hold of the spinner knob and use it to steer the vehicle with one hand. A drawback of this type of steering wheel accessory is that it requires an individual to be capable of firmly gripping the device in order to steer the vehicle.

The palm grip is another steering wheel accessory that attaches to a vehicles steering wheel and permits an individual with limited gripping ability to rest the palm of their hand on the grip and steer the vehicle through the movement of the arm without having to grip anything.

Another steering wheel accessory that works on a similar premise is known as a tri-pin and consists of a trio of pins or protrusions that extend upward from the wheel. This device is designed for individuals who have very limited or no hand function. An individual places his/her hand between the pins and steers the vehicle through the movement of the arm without having to grip anything. A drawback of these types of devices is that the individuals hand may slip free from the device and cause them to lose control of the vehicle.

Examples of the prior art include: U.S. Pat. No. 5,289,736; U.S. Pat. No. 5,870,800; U.S. Pat. No. 3,285,092.

While these devices may fulfill their individual particular objectives and purposes, the aforementioned patented devices do not embody the functional and design features and advantages of this new and improved steering wheel spinner.

### SUMMARY OF THE INVENTION

A first object of the present invention is to provide an improved steering wheel rotating apparatus for permitting an individual with reduced strength and/or functioning of his/her arms to more easily control the steering of an automobile.

A second object of the present invention is to provide an improved steering wheel rotating apparatus that in the event that a non-handicapped person is to ordinarily operate the vehicle, the first component of the apparatus that is attached to the steering wheel will not impair their ability to normally steer the vehicle in any way.

According to the present invention, the steering wheel rotating apparatus is comprised of two components and utilizes magnetic forces to achieve its intended purpose. The first component mounts easily to the steering wheel and possesses an opening equipped with a magnet at its base and the second component attaches to the users' hand and possess a magnetic protrusion that extends downward from said second component to engage with the opening of the first component. The magnet of the first component possesses one magnetic polarity and the magnetic protrusion of the second component possesses a magnetic polarity opposite of that of the first component so that the magnets of the two components attract each other. The user straps the wrist strap component to his/her hand and inserts the magnetic protrusion into the opening on the surface of the first component where the magnetic forces of the two components act to keep the two components engaged. Accordingly, the user is able to rotate the steering wheel through the use of this apparatus without being required to grip either the steering wheel or another device.

### BRIEF DESCRIPTION OF THE DRAWINGS

FIG. 1 is a perspective view of a steering wheel with a first steering wheel mounted component mounted thereto and a second wrist strap component shown above and not engaged with the steering wheel mounted component.

FIG. 2 is a perspective view of a steering wheel with a first steering wheel mounted component mounted thereto and a second wrist strap component shown engaged with the steering wheel mounted component.

FIG. 3 is an overhead perspective view of the steering wheel mounting component of the present invention.

FIG. 4 is a back side perspective view of the steering wheel mounted component of the present invention.

FIG. 5 is a side perspective view of the wrist strap component of the present invention with the securing means open.

FIG. 6 is a side perspective view of the wrist strap component of the present invention with the securing means closed.

FIG. 7 is a front side perspective view of both the steering wheel mounted component and the wrist strap component aligned but separate.

FIG. 8 is a front side perspective view of both the steering wheel mounted component and the wrist strap component aligned and engaged.

### DETAILED DESCRIPTION OF THE PREFERRED EMBODIMENTS

The present invention relates to an improved steering wheel rotating apparatus for permitting an individual with reduced strength and/or functioning of his/her arms to more easily control the steering of an automobile.

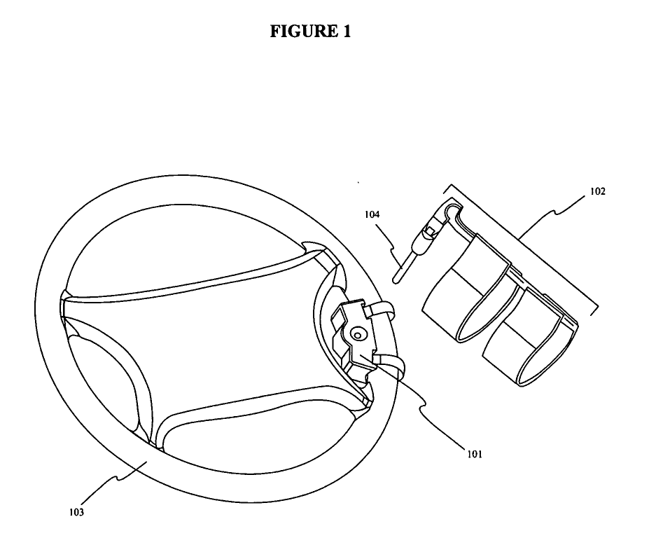

FIG. 1 illustrates an overall view of the primary components of the present invention; the steering wheel mounted component 101, the wrist strap component 102 and a steering wheel 103. As illustrated this figure shows the steering wheel mounted component 101 attached to the steering wheel 103.

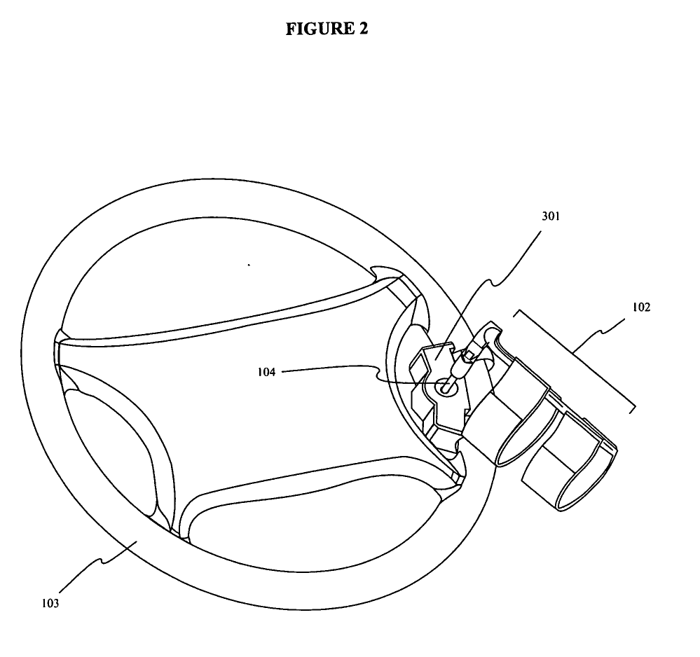

FIG. 2 illustrates an overall view of the primary components of the present invention wherein the steering wheel mounted component 101 is attached to the steering wheel 103 and the wrist strap component 102 is engaged with the steering wheel mounted component 101.

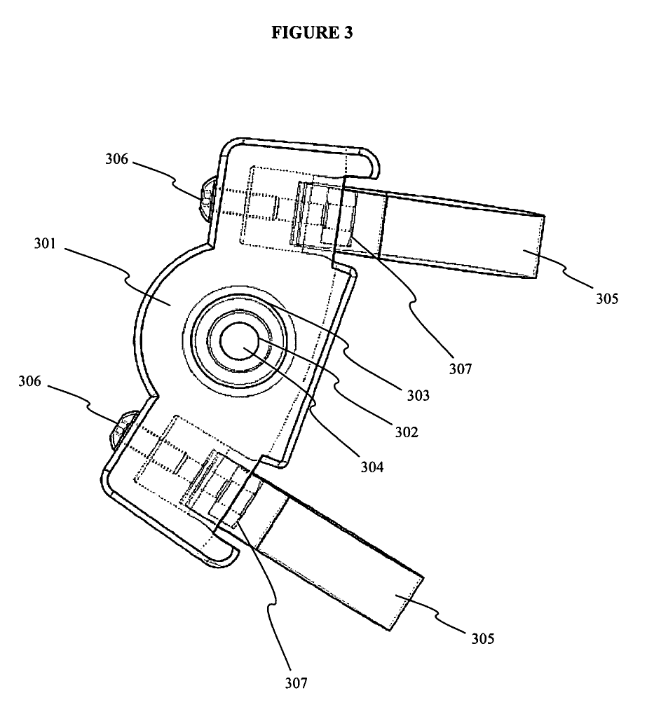

FIG. 3 illustrates an overhead view of the steering wheel mounted component 101. The steering wheel mounted component 101 is comprised of a resin and is fixed to the steering wheel 103 of an automobile or other type of vehicle. The steering wheel mounted component 101 has opposite upper 301 and lower surfaces. The upper surface 301 is possesses an opening 302 in the center of the upper surface 301. The opening 302 on the upper surface 301 is essentially circular in shape and has a larger outer perimeter 303 that is slightly concave toward the inner perimeter of the opening 302 which leads to a cylindrical channel 304 that passes through the steering wheel mounted component 301. The concavity of the outer perimeter 303 assists in guiding the protrusion of the wrist strap component 102 into the cylindrical channel 304 which leads to a magnet at the distal end of the cylindrical channel 304 which engages the magnetic protrusion 104 of the wrist strap component 102. The steering wheel mounted component 101 possesses a plurality of sets of metallic bands 305 which are tightened around the steering wheel and secured in place with bolts 306, and nuts 307.

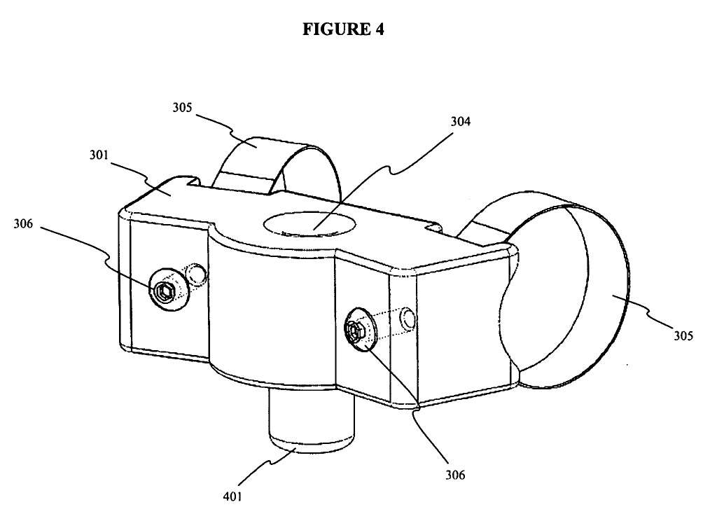

FIG. 4 illustrates a back side perspective view of the steering wheel mounted component 101 of the present invention. Notable in this illustration is the extension 401 of the cylindrical channel 304 below the steering wheel mounted component 101 which extends from the upper surface 301. The extension 401 is equipped with a magnet of a polarity opposite of that of the magnetic protrusion 104 of the wrist strap component 102. The object is that when the magnetic protrusion 104 is inserted into the cylindrical opening 304 and through the steering wheel mounted component 101 it is attracted to the magnet at the bottom of the extension 401 with sufficient force to hold the magnetic protrusion 104 in place and permit its wearer to steer the vehicle. The inner perimeter sides of the cylindrical channel 304 are smooth and permit the magnetic protrusion 104 to rotate freely within the channel 304.

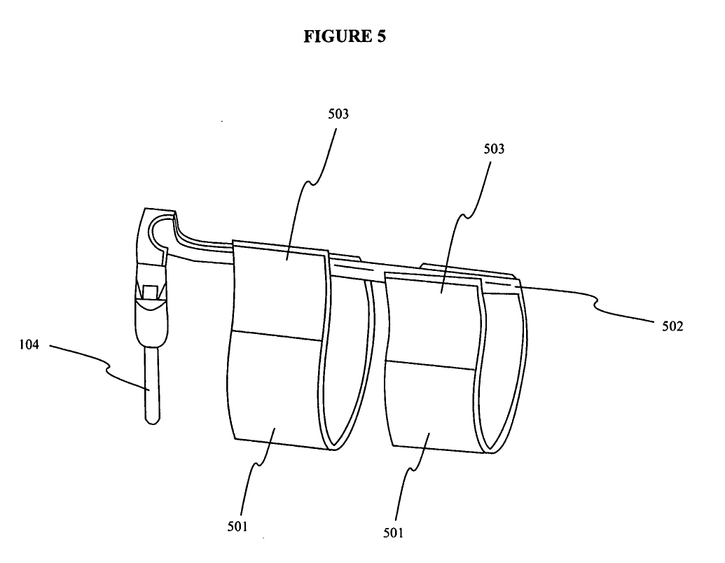

FIG. 5 illustrates a side perspective view of the wrist strap component 102 of the present invention with the securing means 503 in an open position. This figure illustrates one possible embodiment of the wrist strap component 102 wherein it contains a plurality of straps 501 which are designed to wrap around the wearer's wrist. In the embodiment shown the plurality of straps 501 are wrapped around the wearer's wrist and secured in place with a means for securing 503, wherein said means for securing is Velcro, snaps or other suitable means. The wrist strap component 102 also contains a strip of rigid material 502 which extends the full length of the wrist strap component 102 and eventually leads into the magnetic protrusion 104. The strip of rigid material 502 helps to keep the wrist strap component 102 aligned along the length of the wearer's wrist.

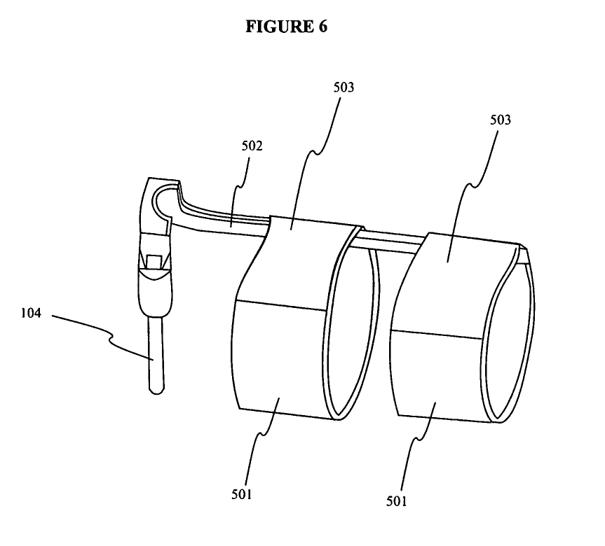

FIG. 6 illustrates a side perspective view of the wrist strap component 102 of the present invention with the securing means 503 in a closed position. This figure illustrates essentially the same features of the present invention as does FIG. 6 with the addition of demonstrating the securing means 503 in a closed position.

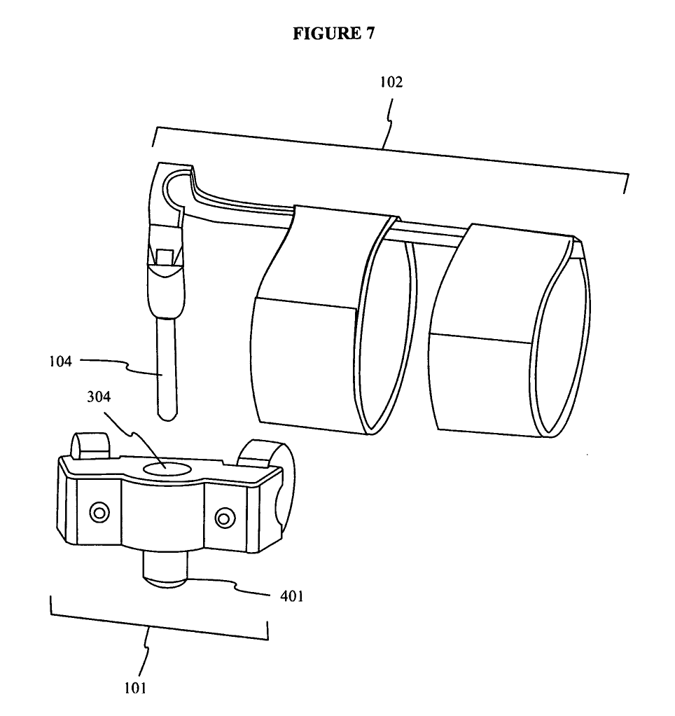

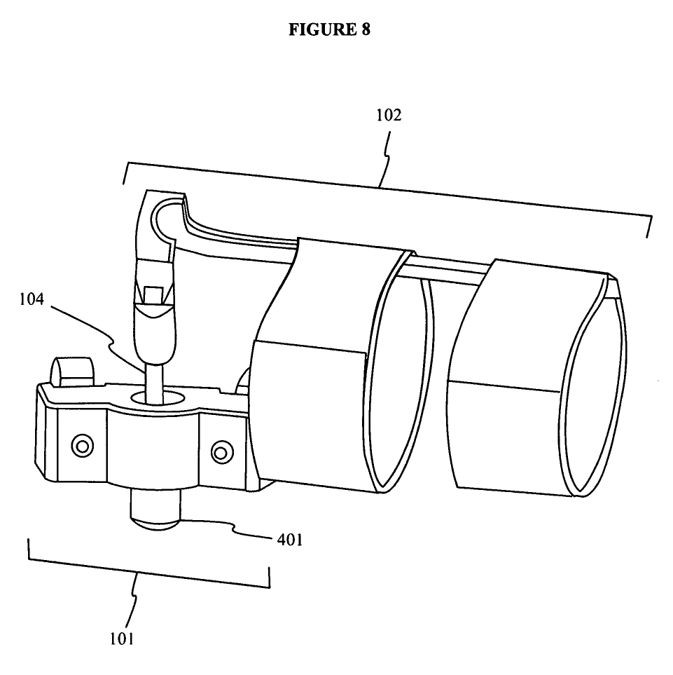

FIGS. 7 & 8 illustrate a front side perspective view of both the steering wheel mounted component 101 and the wrist strap component 102. FIG. 7 illustrates the wrist strap component 102 aligned above the steering wheel mounted component 101 and FIG. 8 illustrates the magnetic protrusion 104 engaged in the cylindrical channel 304 of the steering wheel mounted component 101. The magnetic protrusion 104 of the wrist strap component 102 is aligned directly above the cylindrical channel 304 of the steering wheel mounted component 101. To use the device the wearer of the wrist strap component 102 inserts the magnetic protrusion 104 into the cylindrical channel 304. The magnet located at the distal end 401 of the cylindrical channel 304 exerts a magnetic force that attracts the magnetic protrusion 104 and the magnetic protrusion 104 exerts a magnetic force that attracts the magnet located at the distal end 401 of the cylindrical channel 304. These magnetic forces of attraction function to secure the magnetic protrusion 104 of the wrist strap component 102 to the steering wheel mounted component 101. The attraction between the magnets is strong enough to keep the magnetic protrusion 104 secure in the steering wheel mounted component 101 but is easily released if the wearer exerts an upward pressure in the opposite direction of the magnet located at the distal end 401 of the cylindrical channel 304. Forces exerted in directions other than directly away from the distal end 401 do not dislodge the magnetic protrusion 104.

A number of embodiments have been described. Nevertheless, it will be understood that various modifications may be made without departing from the spirit of the scope of the invention. For example, the physical shapes, dimensions and materials of the various system components (e.g. the wrist straps, means for securing the steering wheel mounted component to the steering wheel, etc.) can vary considerably. For example, in some implementations, the wrist strap component may possess straps that are sealed with Velcro, while in other implementations the straps may be secured with buckles, snaps, or some other suitable means for securing the straps.

Other implementations are within the scope of the claims.

What is claimed is:

1. An apparatus for permitting an individual with reduced strength and/or functioning of his/her arms to more easily control the steering of a vehicle comprising:
a steering wheel mounted component having an opening formed in its upper surface, a magnet embedded in its lower surface at the distal end of the opening formed in its upper surface, and a means for attaching the steering wheel mounted component to a steering wheel of a vehicle;
a wrist strap component possessing a plurality of straps with means for securing said wrist strap component to the wrist of a user, and a protrusion being detachably received in the opening of the steering wheel mounted component where it engages with the magnet embedded in the lower surface of the steering wheel mounted component;

2. The apparatus of claim 1, wherein the protrusion of the wrist strap component is comprised of a metal with magnetic properties.

3. The apparatus of claim 1, wherein the protrusion of the wrist strap component is comprised of a magnet and the magnet is arranged such that the polarity of the magnet is attracted to the magnet embedded in the lower surface of the steering wheel mounted component.

4. The apparatus of claim 1 wherein the means for securing the plurality of straps to the wrist are Velcro.

5. The apparatus of claim 1 wherein the means for securing the plurality of straps to the wrist are buckles.

6. The apparatus of claim 1 wherein the means for securing the plurality of straps to the wrist are snaps.
